(19) United States
(12) Patent Application Publication
(10) Pub. No.: US 2015/0005066 A1
(43) Pub. Date: Jan. 1, 2015

(54) Game Play Control and Ordering Systems and Methods

(71) Applicants: Isaac Krauss, North Hollywood, CA (US); Patrick Jude Barry, Los Angeles, CA (US)

(72) Inventors: Isaac Krauss, North Hollywood, CA (US); Patrick Jude Barry, Los Angeles, CA (US)

(21) Appl. No.: 14/301,947

(22) Filed: Jun. 11, 2014

Related U.S. Application Data
(60) Provisional application No. 61/834,377, filed on Jun. 12, 2013.

(51) Int. Cl. A63F 13/55; A63F 13/822

(52) U.S. Cl. CPC A63F 13/55; A63F 13/822
USPC 463/31

(57) ABSTRACT

A method of implementing player control in a video game is claimed. During a game encounter, a game system defines a deck structure for prospective game actions, allows the user to fill that deck structure with defined prospective actions, and then executes those game actions, using a game engine and a rendering engine, at a rate dependent on in-game conditions and in an order defined by the deck structure. As the effects of those actions are evaluated, the rate at which new actions are executed may be changed, either for a single player or for all of the players in the game. Actions may be predefined or preselected before an encounter, and an action may be a combination of a number of individual constituent actions.

### BACKGROUND OF THE INVENTION

1. Field of the Invention

In general, the invention relates to machine-based gaming, and more particularly, to game play control and ordering systems and methods.

2. Description of Related Art

Gaming, sometimes called video gaming, is one of the most popular pastimes in the United States and throughout the world. Over the years, the industry has evolved as computing power has increased. While the earliest video games had little more than rudimentary graphics and sound, modern games often use fully immersive, high-definition graphics, theater-quality sound, and professional voice actors to create an interactive world.

Traditionally, video games have been played either on dedicated consoles or on general-purpose personal computers (PCs). Although PC-based gaming provides the ability to use a keyboard and other traditional, general-purpose input devices, whether by console or PC, many games are played using hand controllers, which have a limited number of buttons that a player pushes, sometimes in specific combinations or in specific orders, to make specific, game-defined moves. For example, in a traditional fighting game, a player might depress specific buttons repeatedly to produce moves like punches, kicks, and blocks.

The use of controllers has some disadvantages, notably that every game designed for a particular console generally must be adapted to take input from a particular controller, although some games may have specific controllers tailored for them. The controller design and the game design of some games may also allow users to make moves faster than is realistic, e.g., by actuating controls very quickly. Typically, the gaming console or computer provides a hardware buffer that temporarily stores inputs in memory, so that if the user is actuating controls faster than the system can process and respond to the resulting inputs, the excess inputs are stored and processed in a first-in, first-out (FIFO) manner.

In the five years, there have been several paradigm shifts in the gaming industry, particularly in how video games are controlled. First, the advent of cheap, mass-produced sensors has made it possible to create gaming controllers and gaming devices that have positional awareness and position- and rate-dependent activity. For example, the NINTENDO Wii® system (Nintendo of America, Inc., Redmond, Wash.) has a controller with a three-dimensional accelerometer, making it possible to sense the orientation and velocity of the controller. This has made possible a host of games in which the user makes physical motions that mimic the motions that he or she wishes a game character or element to make.

Second, touch-screen devices, many of them also equipped with accelerometers and other sensors, have become more and more popular as gaming platforms. For example, the Apple iPHONE® and iPAD® (Apple, Inc., Cupertino, Calif.) and ANDROID®-based Samsung GALAXY® devices are all popular gaming devices, each having an application store with thousands of games available. Each of those devices has at least an accelerometer.

The particular challenge for game designers is that touch-screen devices have no predefined or pre-set modes of input—in a game, the interface can present any type of buttons, and may also take input from the physical sensors. Thus, the interface for each game, the mode of interacting with the game elements and characters, can vary widely, and the industry is still experimenting with the best and most popular ways for users to interact with games. Modes of input that make better and more innovative use of a device's capabilities tend to be more popular and to generate more revenue.

### SUMMARY OF THE INVENTION

One aspect of the invention relates to a method of implementing player control in a video game. This method begins by presenting a deck structure to hold potential actions. Once a deck structure has been created, typically during an encounter within the video game, the user is allowed to populate the deck structure with defined actions. Those defined actions are executed at a rate determined at least in part by in-game conditions. Typically, a deck structure is defined for each player in an encounter, whether that player is controlled by a user or by the game program. The effect of each action or combination of actions, and ultimately, the winner of an encounter, is determined by a game engine evaluating the actions that are chosen by each player. As the game engine determines the effect of each of the actions, the rate at which the actions are executed for each player or for particular players may be altered.

Other aspects, features, and advantages of the invention will be set forth in the description that follows.

### BRIEF DESCRIPTION OF THE DRAWING FIGURES

The invention will be described with respect to the following drawing figures, in which like numerals represent like features throughout the invention, and in which:

FIG. 1 is a schematic illustration of a system according to one embodiment of the invention;

FIG. 2 is a schematic illustration of the use of the system of FIG. 1 in a multiplayer online environment;

FIG. 3A is a flow diagram of a method for controlling game play according to another embodiment of the invention;

FIG. 3B is a flow diagram of a portion of the method of FIG. 3A;

FIGS. 4-9 are illustrations of character selection and resource allocation screens in an exemplary Mixed Martial Arts game;

FIG. 10 is a schematic illustration of the manner in which a game encounter may be shown, including deck structures;

FIG. 11 is a schematic illustration of an alternate mater in which a game may be shown.

FIG. 12 is an illustration of an encounter in the Mixed Martial Arts fighting game of FIGS. 4-9.

### DETAILED DESCRIPTION

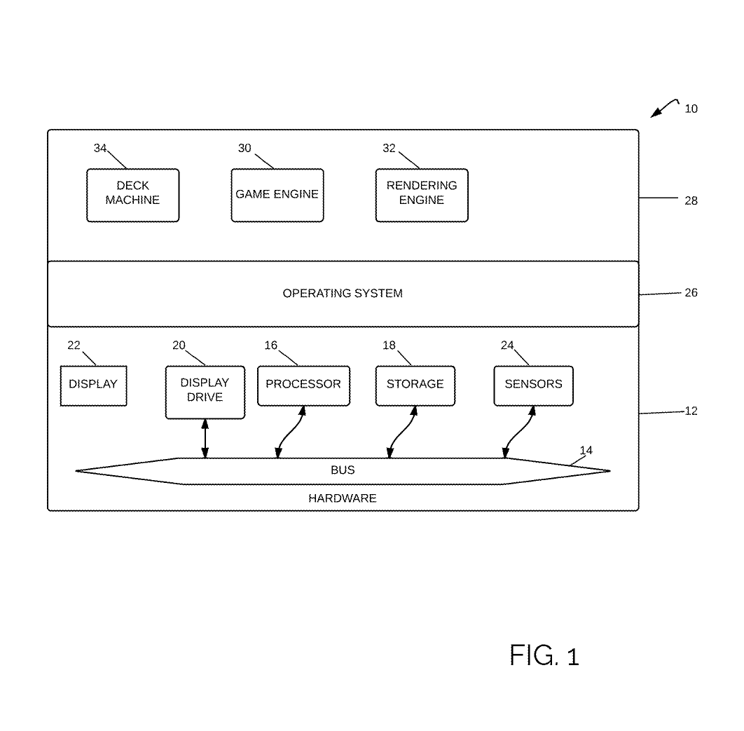

FIG. 1 is a schematic diagram of a system, generally indicated at 10, for gaming and implementing gaming control and flow methods according to embodiments of the invention. As FIG. 1 illustrates, systems according to embodiments of the invention generally comprise combinations of hardware and software. The hardware 12 may be a general-purpose computer, a smartphone, a tablet, or any other form of device capable of performing the tasks that will be described below.

As those of skill in the art will appreciate, the hardware 12 typically has a communication bus 14 that enables its components to communicate. Connected to the bus 14 are a processor 16, storage 18, and display drivers 20 that drive a display 22. The storage 18 may comprise random access memory (RAM); read-only memory (ROM); flash memory or solid-state drives; traditional magnetic media, like hard disk drives; or any combination of those storage mechanisms. Certain aspects of this disclosure assume that the display 22 is a touch-screen display that is also responsible for collecting user input, although that need not necessarily be the case in all embodiments. As shown in FIG. 1, the hardware 12 may also include one or more sensors 24, such as accelerometers, that provide information on the physical orientation or other characteristics of the hardware 12.

Interfacing with the hardware 12 is an operating system 26. The operating system 26 would generally be resident on the storage 18 and be run using the processor 16 to handle basic input-output, to communicate with and control the hardware 12, and to perform other, lower-level functions. However, for explanatory purposes, the operating system 26 is shown lying overtop the hardware 12, which is its logical place in system 10.

Running on the operating system 26 is a game program 28. Whereas the hardware level 12 represents a number of physical components, the operating system 26 and game program 28 are both software components, sets of hardware-readable instructions that are interoperable with the hardware 12 to perform desired functions. FIG. 1 illustrates that the game program 28 may be divided conceptually into a number of engines or modules. These engines or modules are illustrated and described separately for ease and convenience in explanation; in actual implementations, their functions may be divided up or performed differently.

Of the modules, the game engine 30 will be assumed in this description to have overall control of game flow and game activities. Coupled to the game engine 30 is a rendering engine 32 responsible for game graphics. Also shown in FIG. 1 as a part of the game program 28 is a deck machine 34.

In the following description, it is assumed that one or more players may play games using system 10 individually. Additionally, in some embodiments, multiple game systems 10 may be used in multiplayer online environments, such as for social gaming or massive multiplayer online (MMO) environments. Social gaming and MMO environments differ primarily in the overall number of players participating and the number of players cooperating or opposing one another in a particular encounter.

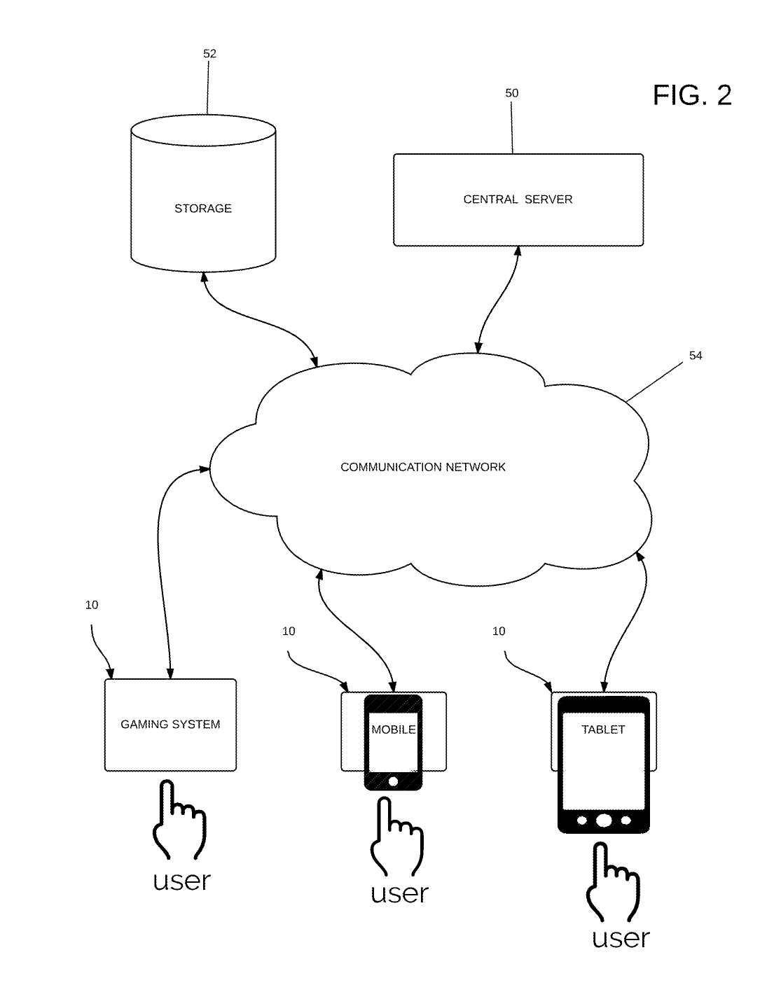

FIG. 2 is a schematic diagram of a system in which multiple game systems 10 of FIG. 1 are in communication with a central server 50 through a communication network 54, such as the Internet. The central server 50 has access to storage 52 and performs administrative functions, allowing multiple users, each at his or her own game system 10, to play with or against each other over the network 52. As those of skill in the art will understand, an MMO environment, such as that illustrated in FIG. 2, may include tens, dozens, hundreds, or thousands of players, all playing games simultaneously.

As a practical matter, although one central server 50 is shown for ease in illustration, any number of servers 50 may be present and may be configured, configured, or connected together to act as a single logical machine. Alternatively, more servers 50 may be recruited and pressed into use as the demand and activity on the network increase. In some embodiments, the central server or servers 50 may be maintained and operated by the entity that controls the system; in other embodiments, the central server or servers 50 may be part of a shared computing environment used by many different entities.

While MMO environments are one option, in some games, if more than one player is required or desired and only one player is available, additional players may be simulated by system 10.

The game system 10 of FIGS. 1 and 2 implements novel methods of user control in video games. Rather than simply asking a user to repeatedly hit combinations of buttons on a controller to control a game, a game system 10 defines a deck structure for prospective game actions, allows the user to fill that deck structure with defined prospective actions, and then executes those game actions, using the game engine 30 and rendering engine 32, at a rate dependent on in-game conditions and in an order defined by the deck structure. The game engine 30 is primarily responsible for determining the result of any action that is executed and for instructing the rendering engine 32 to render appropriate graphics, while the deck machine 34 creates and maintains a graphical user interface (GUI) that allows the user to insert the prospective game actions into the deck structure.

As the term is used here, the term “deck structure” refers to the data structure that contains the prospective game actions and any graphical representations of it that may be provided as part of a game's GUI. Depending on the game, the deck structure may be a first-in, first-out (FIFO) data structure, such as a queue; a last-in, first-out (LIFO) structure, such as a stack; or a list that is executed in its specified order, but to which prospective game actions may be added at any position.

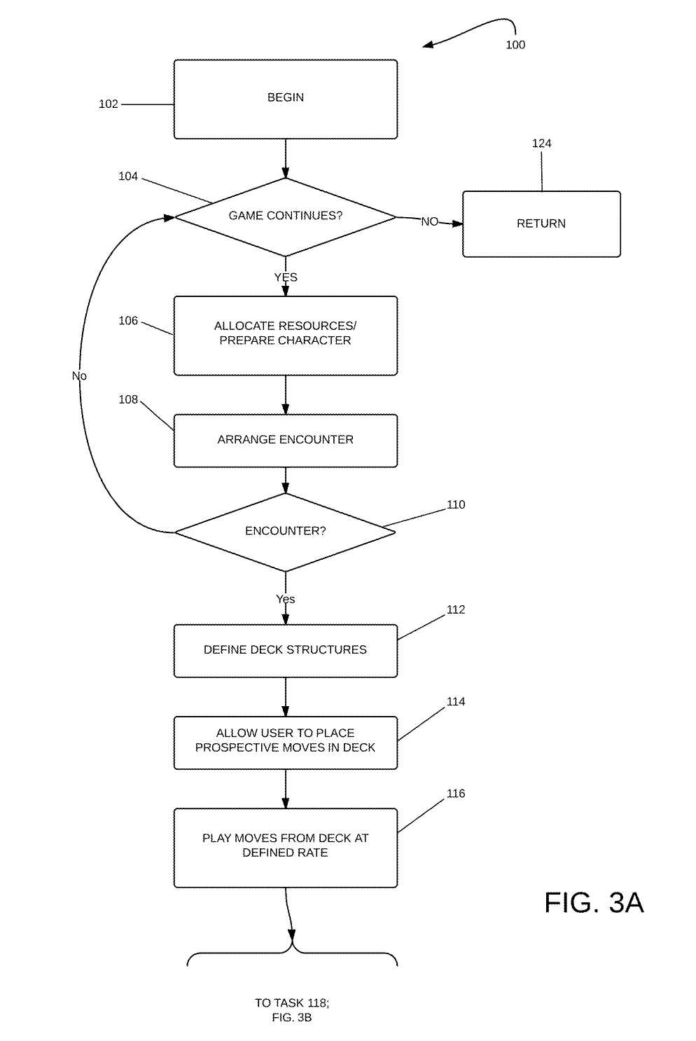

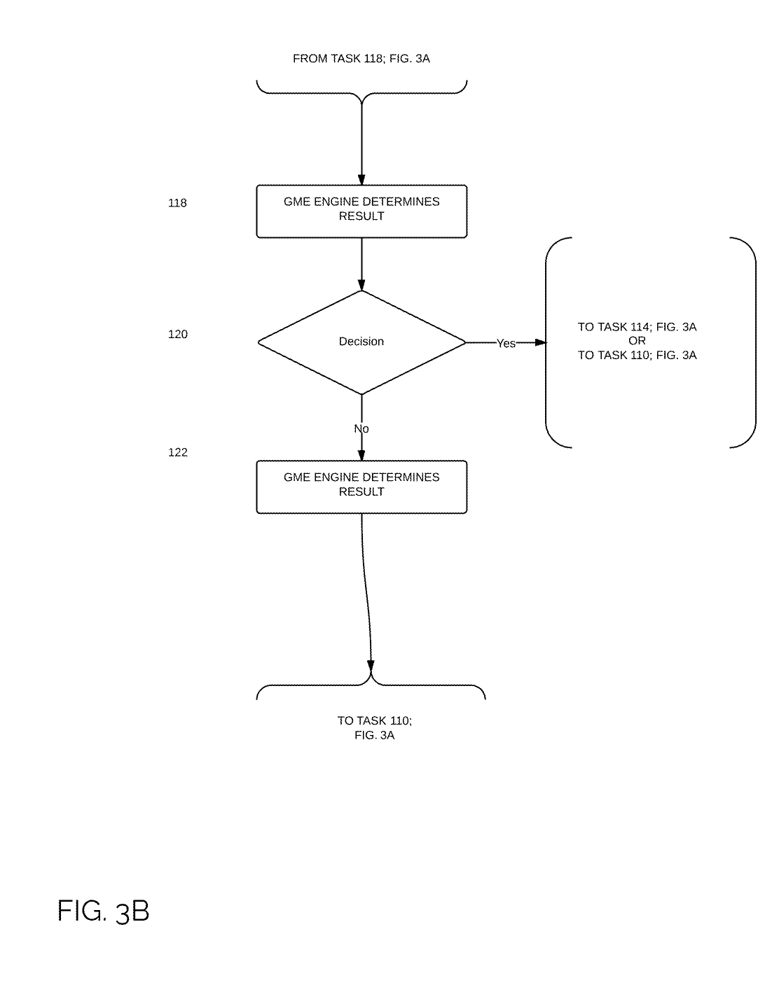

FIG. 3A is a flow diagram of a method, generally indicated at 100, for controlling game play according to another embodiment of the invention. Method 100 begins at task 102 and continues with task 104. Task 104, a decision task, marks the beginning of the main “loop” or iterative structure of the game. While the game continues (task 104:YES), method 100 continues with task 106.

In the following description, a mixed martial arts (MMA), character driven game may be used as an example of how certain features might be implemented or used. However, any number of different types of games may be implemented that embody the described features. Task 106 is an optional task and need not be present in all embodiments, but represents a feature common to many different types of games: resource allocation and preparation for fights, encounters, or challenges.

In many different types of games, it is common to provide a user with some choices as to the character or side that he or she is playing in a game. This may be done by giving the user a fixed set of options and allowing the user to choose from among those options, or it may be done by giving the user a limited set of resources or attributes and allowing the user to allocate those resources and attributes as desired. For example, in an MMA game, a user may be given the option to choose among fighters with different specified attributes: strength, speed, body type, specialties, etc. Alternatively, a user may be given a fixed number of “attribute points” and may be permitted to define a character by deciding which attributes to focus on and improve by allocating those attribute points. Still other games allocate a certain amount of in-game currency to the user and allow him or her to spend that currency on in-game items that improve character performance. Task 106 provides for this kind of resource allocation and character definition. Of course, numerous variations of this basic concept may be used in embodiments of the invention.

Task 106 also provides for a training or improvement phase, in which a user might test his or her character's or side's abilities in a situation where the results are informal or do not apply toward game objectives. This process of resource allocation, preparation, and training may continue iteratively for some time before method 100 continues with task 108.

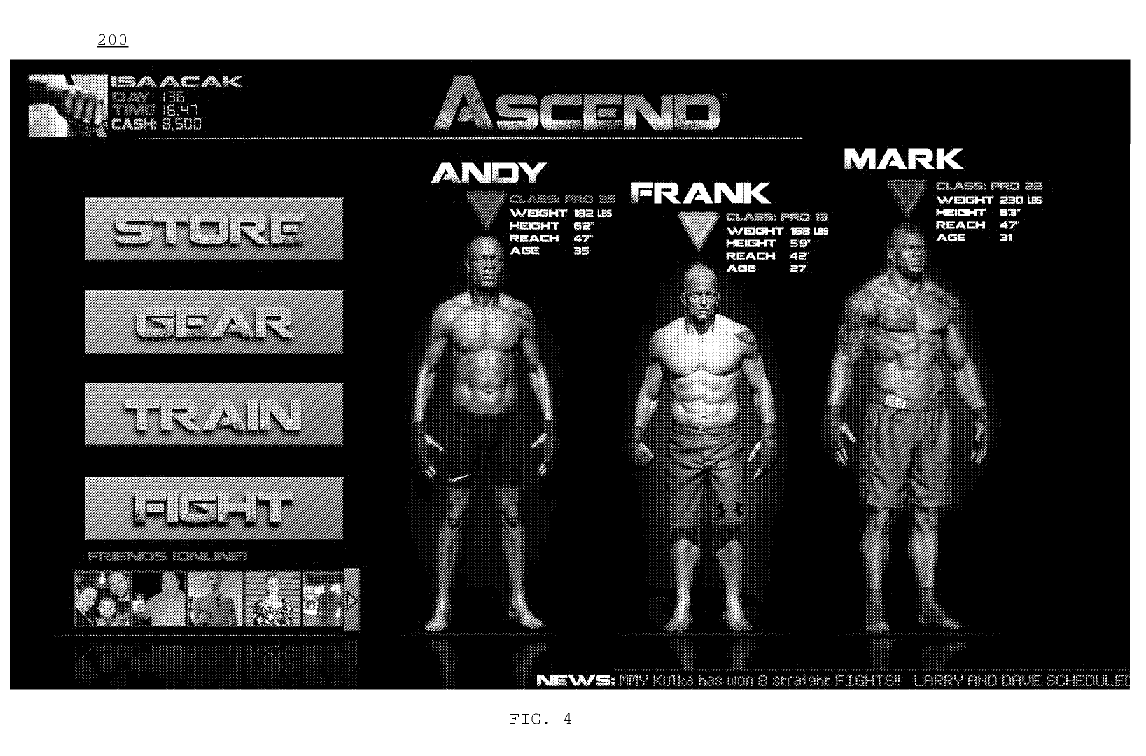

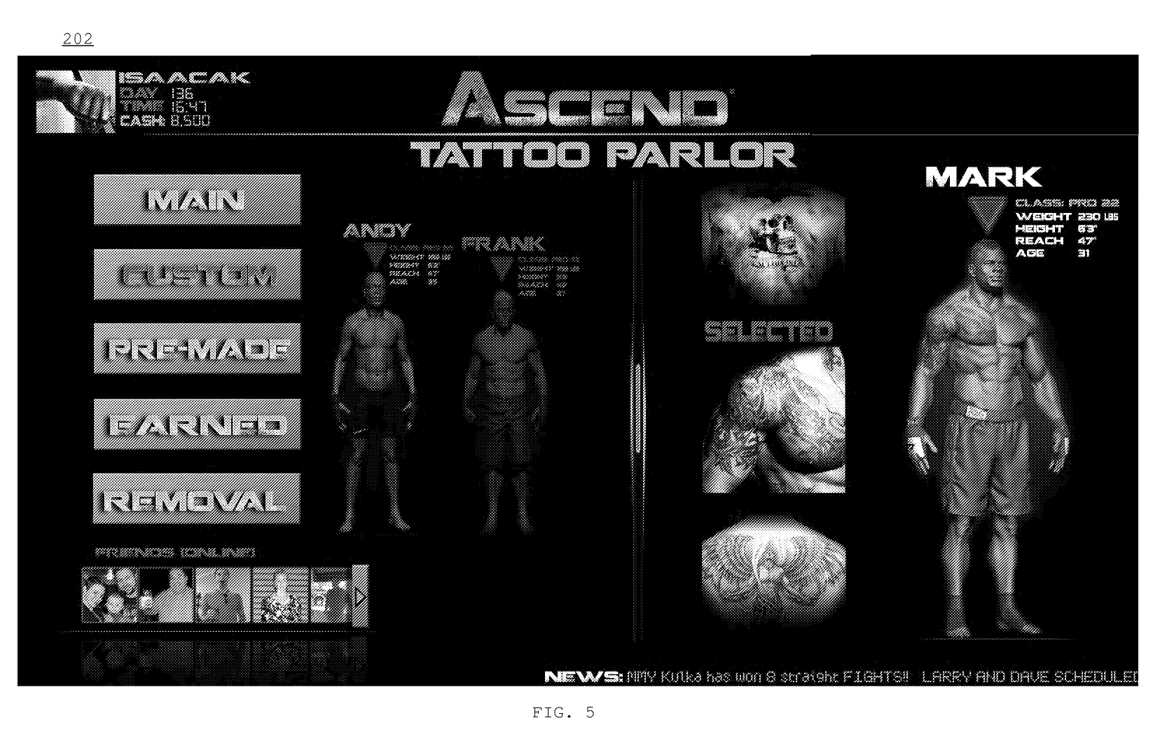

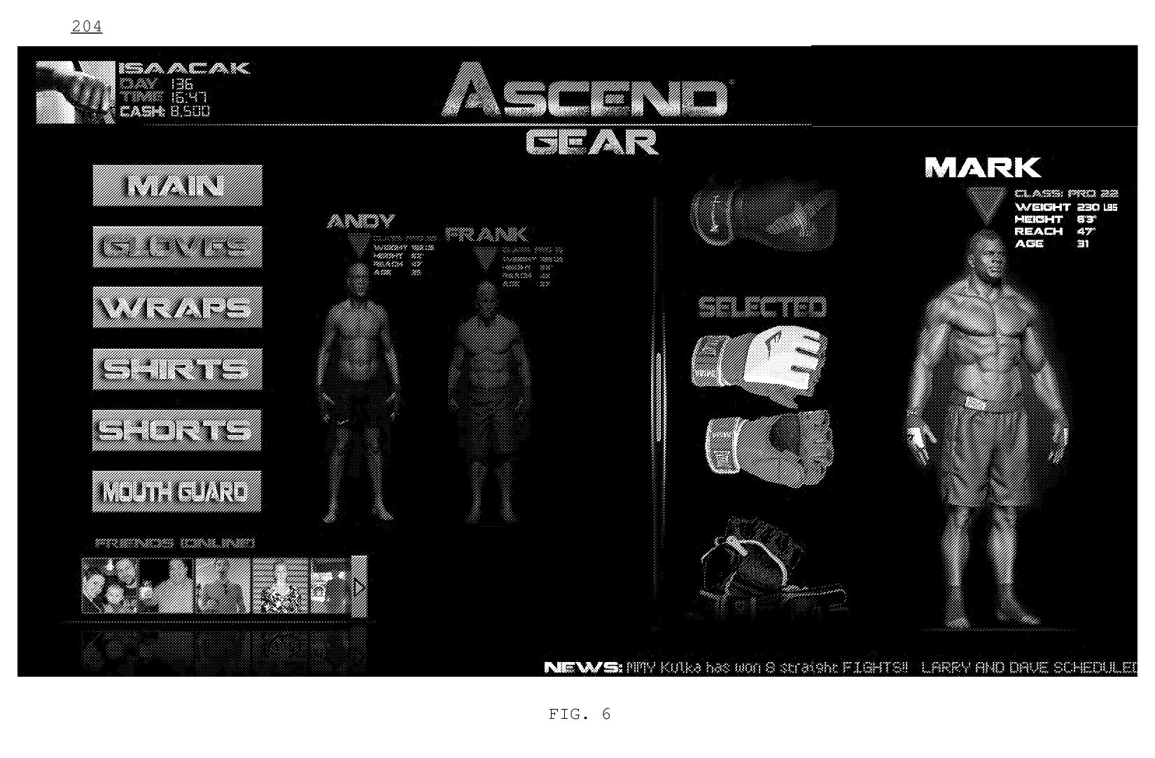

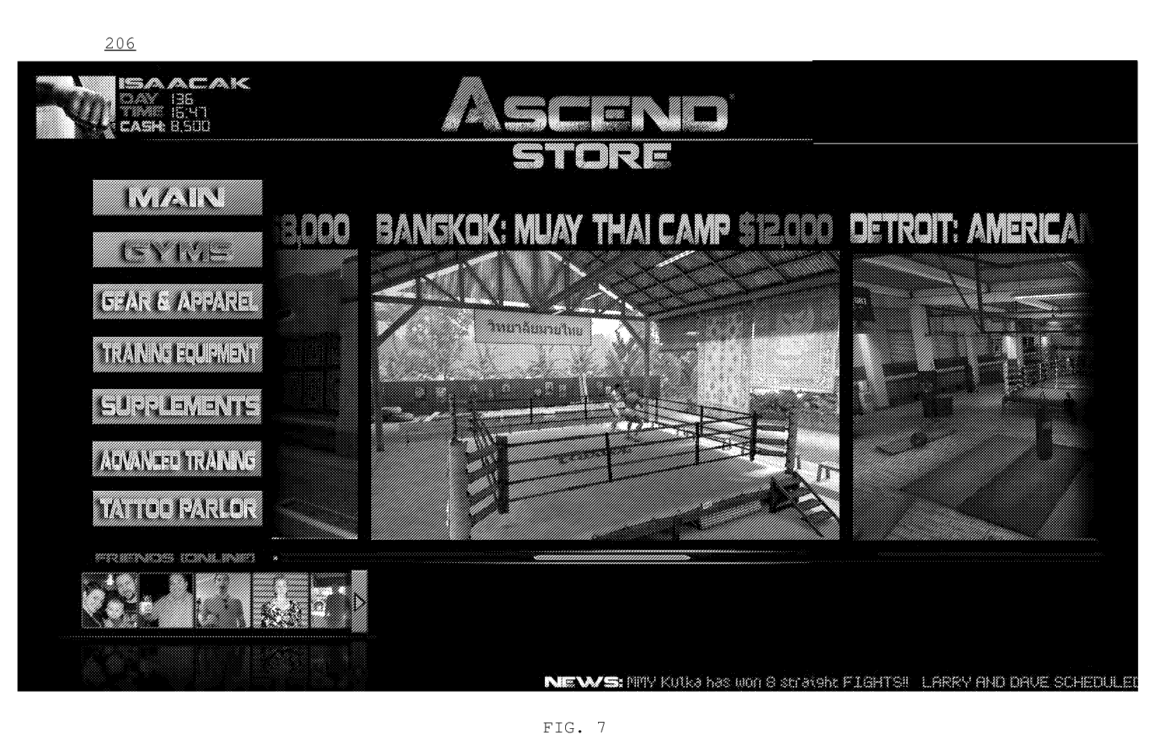

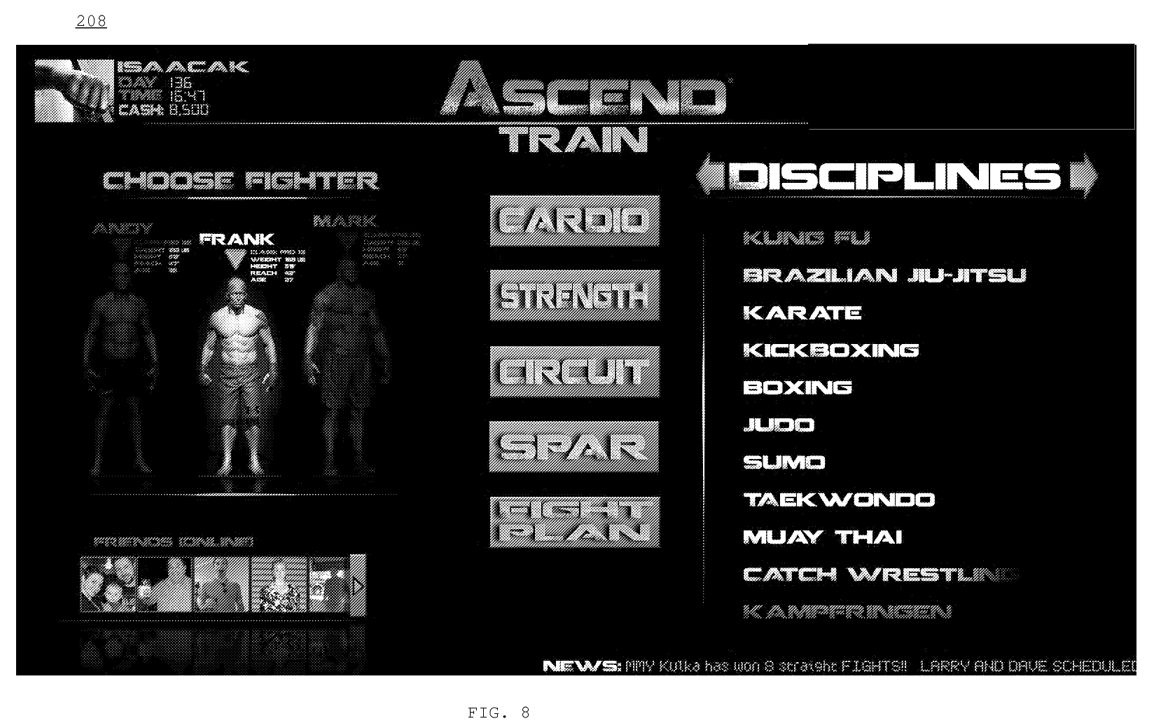

FIG. 4 is a schematic illustration of the GUI of an MMA game, illustrating one way in which task 106 may be accomplished. FIG. 4 specifically illustrates a character selection screen 200 that allows the user to choose from among three illustrated characters, each with defined characteristics, which in this case are weight, height, reach, and age. Once the basic character is selected, FIG. 5 illustrates a decoration selection screen 202 that allows the user to decorate his or her character by selecting particular tattoos for his or her character from among a number of options. Once the character is selected and customized, gear selection screen 204 of FIG. 6 allows the user to choose gloves, wraps, and clothing for the character. Additionally, location selection screen 206 of FIG. 7 allows the user to choose a training location for the character, and discipline selection screen 208 of FIG. 8 allows the user to select particular martial arts disciplines in which to train the character.

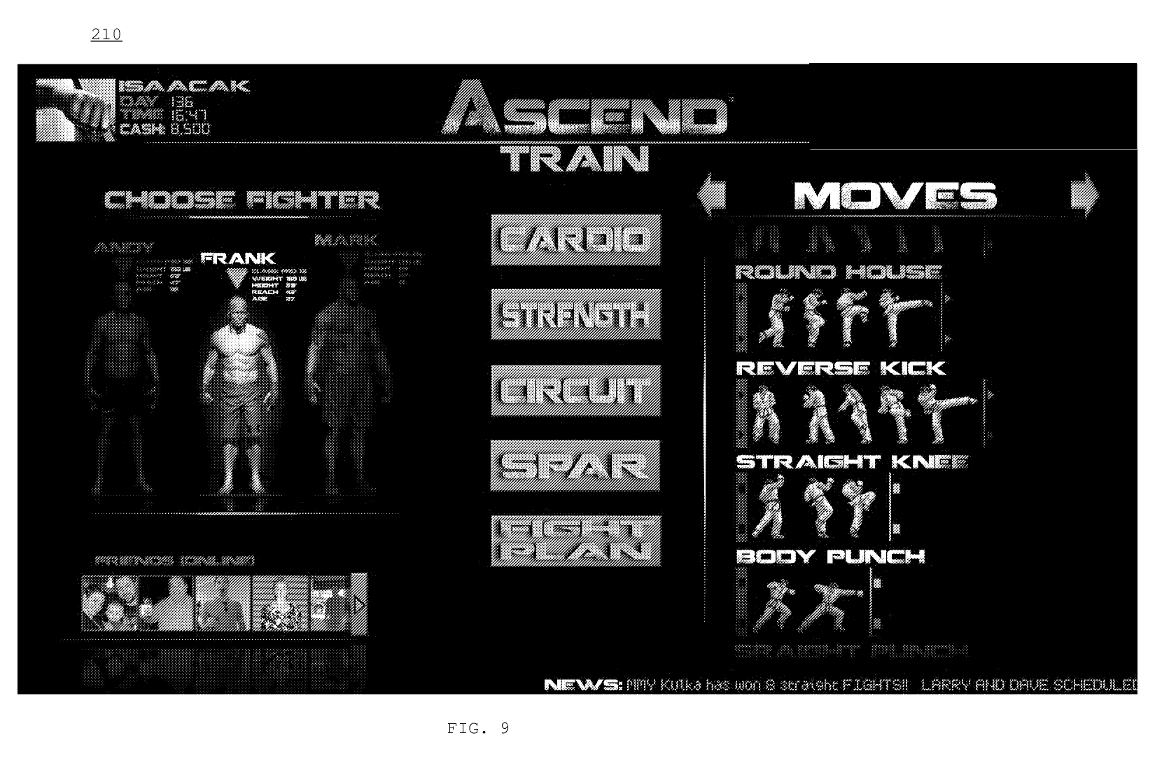

While task 106 may be accomplished in any number of ways, one advantageous effect is to define the “universe” of moves or actions that a character or side will be capable of performing in later parts of the game. To that end, continuing the example of FIGS. 4-8, move selection screen 210 of FIG. 9 allows the user to select and practice specific moves and combinations of moves with his or her character. Thus, at the conclusion of task 106, each user has at least one defined character with a “universe” of defined moves. Of course, in games that are not role-playing in nature, users may be presented with less elaborate choices and options, or task 106 may be omitted entirely.

In task 108, the game engine 30, or another module, arranges an encounter for the user. An encounter, as the term is used here, refers to any kind of in-game event where the user tests his character's or side's abilities in competition with another player. That other player may be a live player, particularly in an MMO environment, or a computer-simulated player. In an MMA game, an encounter would typically be a fight with another player. In other games, an encounter may be a game level or a puzzle.

The manner in which an encounter is arranged in task 108 will depend on the game and the circumstances. In an MMO environment, arranging an encounter may involve inviting the user to choose from among currently available players. The list of available players may be further narrowed or filtered in some embodiments to show only those players with whom the user has already connected in an internal or external social network, such as FACEBOOK® or GOOGLE PLUS®. A matching algorithm, or at least a set of basic rules, may be implemented to ensure that the encounter is fair based in the characteristics of each player character. For example, in an MMA game, algorithms may ensure that only characters of the same weight class are matched, or only characters within a certain range of experience level. Encounters may be single encounters with a defined player or players, or encounters as part of a tournament or a larger, organized group of players.

Method 100 continues with task 110, a decision task that indicates the beginning of an encounter. During an encounter (task 110:YES), a deck structure is defined, as shown in task 112 of FIG. 3A. Typically, one deck structure is defined per player in the encounter. As was noted briefly above, if a player is simulated and controlled by the computer, a deck structure would be instantiated and controlled by the computer.

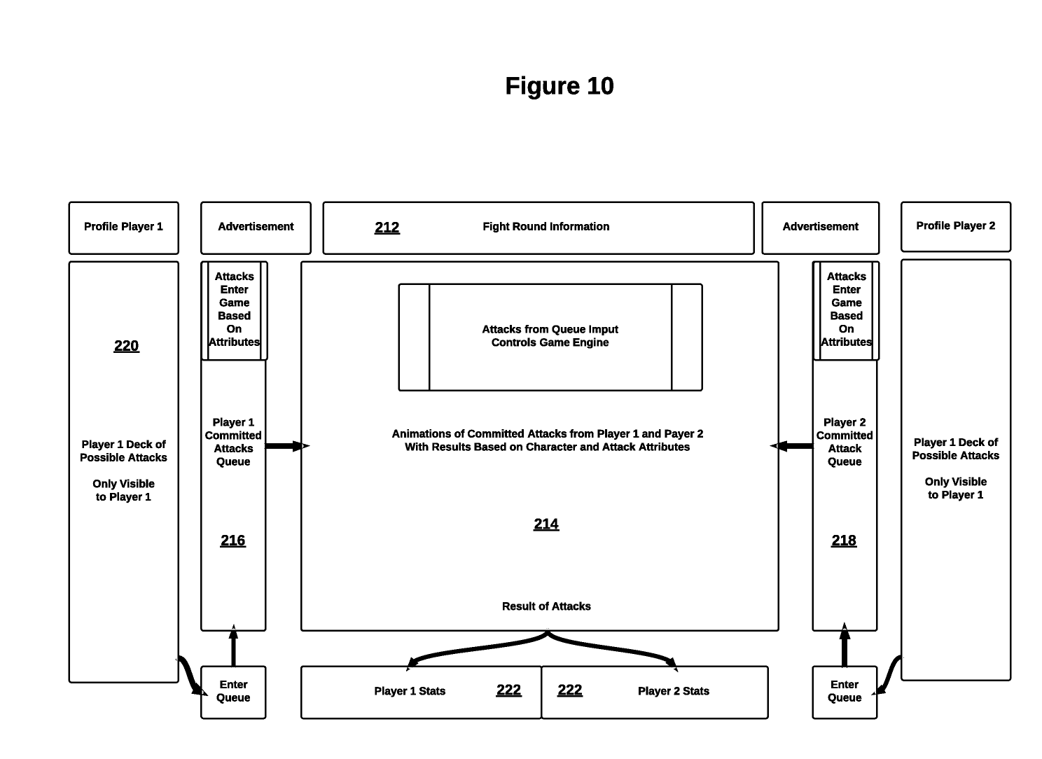

FIG. 10 is a schematic illustration of an encounter screen 212, one way in which an encounter might be illustrated in a game, such as an MMA game. The encounter screen 212. The encounter screen 212 includes a large, generally central animation area 214 where animations of the two characters in the encounter are shown 214. In a fight game, the animation area 214 is where the fight would be “shown.” The encounter screen 212 also illustrates two deck structures 216, 218, one deck structure 216 for the human player and one for another player. To the left of the deck structure 216, a graphical deck machine 220 allows the user to create prospective actions or moves that are placed in the deck 216. The encounter screen 212 also provides an informational space 222 which provides information on the condition of each player during the encounter. As will be described below in more detail, the condition of each player is one of the potential in-game conditions that affect the game.

With respect to method 100 of FIG. 2, once the encounter has begin and the deck structures have been created in task 112, rather than hitting specific buttons to execute specific moves, the user is allowed in task 114 to place prospective moves in the deck structure 216 for his or her player. As shown in task 116, moves that are placed in the deck are ultimately played or executed at a defined rate. That defined rate is dependent on in-game conditions, and may be constant or vary during an encounter, depending on the game and the conditions.

The initial rate at which moves are played from the deck structure may be defined by basic character attributes. For example, in an MMA game, the rate of move play for a taller, heavier character may initially be slower than the rate of move play for a smaller, lighter character. Users may have the ability to use character characteristics like aggression and perseverance to speed up the rate at which moves are played from the deck. Similarly, as a character becomes injured, the rate of move play may slow. In some implementations, users may also choose the speed at which the game is played, which may, in turn, determine an overall basic rate of play for the deck structures.

Graphically, the deck structures 216, 218 may be illustrated as animated conveyor belts in some embodiments, with the rate of graphical advance reflecting the defined rate at which moves are played from the deck structure 216, 218. In other embodiments, the deck structures 216, 218 may be illustrated differently.

The deck machine 34 and its GUI 220 allow the user to select moves and combinations of moves to be placed in the deck structures 216, 218. Each move in the known universe of moves would usually be depicted, listed, or otherwise displayed in the deck machine GUI 220, although certain moves may be removed or made unselectable if they are inappropriate or not possible at certain points in an encounter. A user might select those moves by scrolling through the list and tapping the move with a finger, or dragging it into the desired position in the deck structure 216. (In some embodiments, the deck structure 216, 218 may be a FIFO or LIFO structure, as was noted above, with new moves automatically placed in a designated location.) In other embodiments, a user may select a whole sequence of moves by dragging his or her finger, continuously and in order, over icons indicating the desired moves in order to place all of those moves in the deck structure 216 in the designated order. In yet other embodiments, if the game system 10 has an accelerometer 24, moves may be selected by making specified, predefined movements with the game system 10 itself to place moves into the deck structure 216.

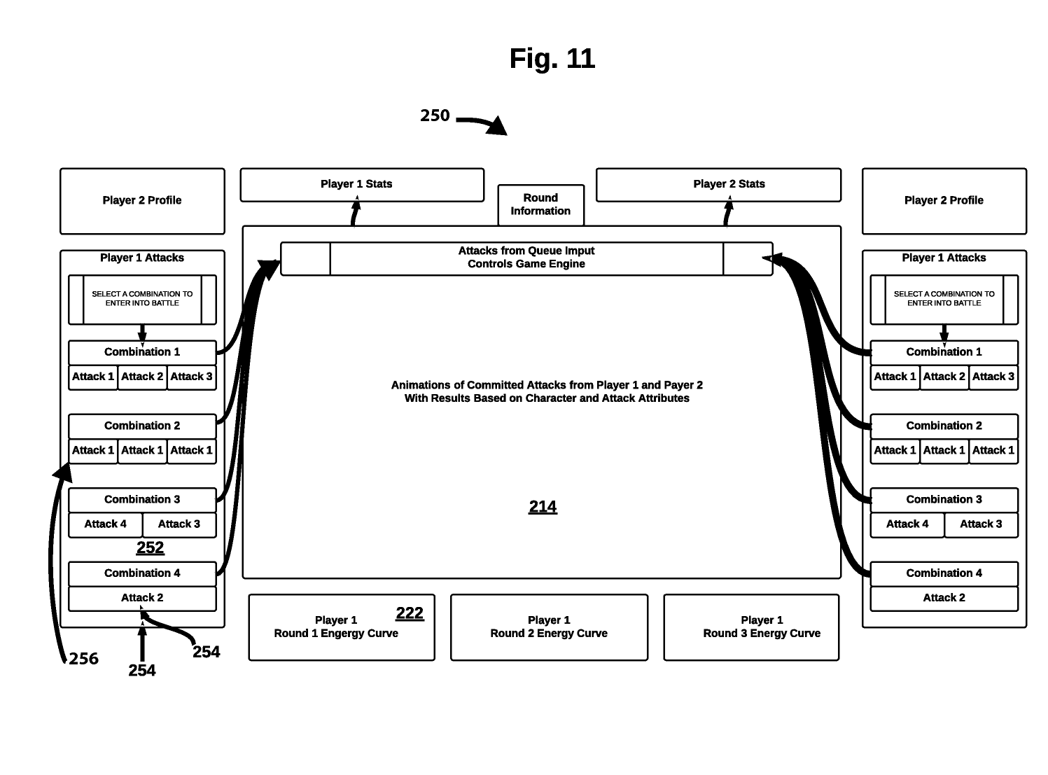

Of course, the illustration of FIG. 10 is but one way that a GUI for an interface may be implemented. FIG. 11 is an illustration of an alternate encounter screen 250. The encounter screen 250 includes a deck machine 252 in which the user is provided with a defined set of combinations of moves (presumably the moves that were practiced and established as a result of task 106 of method 100), chooses a move, and taps, slides, or otherwise actuates a launcher button 254. Compared with the deck structures 216, 218 illustrated in FIG. 10, which may have 5-10 positions to be filled, the deck structure 265 of the encounter screen 250 has only two positions—the move that is currently being “launched” into the game (at a defined rate based on in-game conditions), and one move after that. Of course, a deck structure may have any number of positions. More positions in a deck structure may lend themselves to more strategic thinking and more strategic games, while fewer positions in a deck structure may add more immediacy to the game.

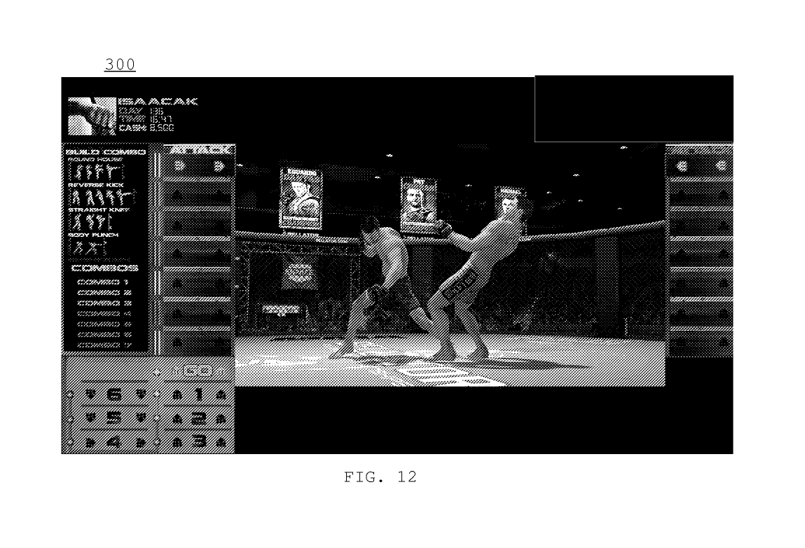

FIG. 12 is an illustration of an encounter screen 300 as it might appear in the game of FIGS. 4-9. As shown, the encounter screen 300 is similar in arrangement and characteristics to the encounter screen 212 of FIG. 10.

Once a move has been played or executed in task 116, method 100 continues with task 118, illustrated in FIG. 3B. In task 118, the game engine 30 considers the action or move played by each player and determines the results, if any, of the action or move having been played. This would typically be done by numerical simulation using game-specific rules. For example, in an MMA game, if one player kicks and the other punches, the game engine 30 decides the result of those moves having been executed.

In some embodiments and in some games, it may be possible for a user to leave some positions in a deck structure unpopulated with prospective actions. If the user does not populate each position, the game engine 30 may be instructed to consider an unpopulated position in the deck structure as a predefined default move. In game terms, this default move may be, e.g., a particular defensive posture.

After the result of a move has been determined in task 118, method 100 continues with task 120 of FIG. 3B, a decision task. In any encounter, there are certain break points. One obvious breakpoint occurs if a particular character or side is calculated to have lost the encounter, at which point the encounter ends. Additionally, in some cases, users may designate a point at which they are willing to break from a combination of moves in order to react to an opponent's moves, or to take different action if the moves that were placed in the deck are not working. If a break point has been reached (task 120:YES), control of method 100 returns either to task 114 of FIG. 3A or to task 110 of FIG. 3A, depending on the nature of the break that is detected.

If there has been no break point and the encounter is to continue (task 120:NO), method 100 continues with task 122, and the rates at which actions or moves are played from the deck structures are recalculated for each of the deck structures. Thus, if one character has been injured, the rate of play for that character may be slowed.

Once task 122 is complete, control of method 100 returns to task 110 to determine whether the encounter should be continued. If the encounter is over (task 110:NO), control of method 100 returns to task 104, where it is determined whether the game is to be continued. If the game is not to be continued (task 104:NO), method 100 terminates and returns at task 124. Of course, method 100 of FIGS. 3A and 3B is a basic one, and additional tasks may be necessary or desirable in particular games or in particular embodiments.

In some cases, the effect of the deck structures in combination with the potentially variable and condition-dependent rate at which actions are played or executed is to mimic the natural way that a human would act in a real situation. In many games and sports, the participants consider their movements and actions one or two moves ahead of the current situation. The use of a defined set or “universe” of moves may also add realism, as athletes, for example, will rarely execute moves on the field that have not been tried in practice.

If realism is not the goal of the game, deck structures and condition-dependent rate of action play may be tied to completely different in-game conditions. For example, rate of action play may be automatically faster after a certain amount of time has elapsed in an encounter, automatically faster or slower after a certain round or portion of an engagement, or randomly chosen at different points during the encounter to add excitement. In some cases, one player's rate of action play may be randomly increased and another player's rate decreased.

While the invention has been described with respect to certain embodiments, the embodiments are intended to be exemplary, rather than limiting. Modifications and changes may be made within the scope of the invention, which is defined by the appended claims.

What is claimed is:

1. A method of implementing player control in a video game, comprising:
defining a deck structure for prospective actions in a computer-implemented game;
allowing a user to populate said deck structure with defined prospective actions;
implementing said defined prospective actions, using a game engine running on a machine, at a rate determined at least in part by in-game conditions.

2. The method of claim 1, further comprising displaying graphical representations of said deck and said defined prospective actions to the user using an electronic display.

3. The method of claim 1, wherein said defined prospective actions comprise combinations of individual constituent actions.

4. The method of claim 3, further comprising, before said allowing, defining said defined prospective actions based on said individual constituent actions.

5. The method of claim 1, wherein said allowing and said implementing occur during an encounter between two or more players.

6. The method of claim 5, wherein said defining the deck structure further comprises defining a deck structure for each of the two or more players.

7. The method of claim 6, wherein said implementing further comprises:
taking one of said defined prospective actions from each of the two or more deck structures; and
evaluating said two or more defined prospective actions to determine an effect of said defined prospective actions on each of the two or more players.

8. The method of claim 7, further comprising, after said evaluating, changing the in-game conditions based, at least in part, on the effect.

9. The method of claim 8, further comprising changing said rate for at least one of the two or more players.

10. The method of claim 1, wherein the user populates the deck structure using a touch screen to provide input.
